(19) United States
(12) Patent Application Publication
(10) Pub. No.: US 2011/0193821 A1
(43) Pub. Date: Aug. 11, 2011

(54) HYBRID BUTTON DEVICE WITH A TOUCH SENSING FUNCTION

(76) Inventors: Sang Hyun Han, Gyeonggi-do (KR); Gi Beom Kim, Seoul (KR)

(21) Appl. No.: 13/123,675

(22) PCT Filed: Oct. 14, 2009
(86) PCT No.: PCT/KR2009/005900

§ 371 Date: Apr. 11, 2011

(30) Foreign Application Priority Data
Oct. 21, 2008 (KR) 10-2008-0103175

(51) Int. Cl. G06F 3/045

(52) U.S. Cl. 345/174

(57) ABSTRACT

Disclosed is a hybrid button device for use in a variety of host systems. The device includes a button unit and a capacitance measuring unit. The button unit controls various functions of a host system using a control unit and in response to a manipulation made by a user. The button unit includes a PCB pattern and a dome sheet and is manipulated by the user so that when the button unit is pushed by the user, a corresponding key value is output to control a function of the host system. The capacitance measuring unit is connected to the button unit and measures the capacitance when the user touches the button unit. When the user touches the button unit, the capacitance measuring unit determines whether to operate or not, and a corresponding key value is output by the control unit to control a corresponding function of the host system. The present invention is advantageous in that the button device having a touch sensing function can easily be implemented without having to modify the structure of a digital device having a pre-existing button unit.

### TECHNICAL FIELD

The present invention relates generally to hybrid button devices having touch sensing functions and, more particularly, to a hybrid button device in which a touch sensing function for touch manipulation is added to an existing button which is manipulated by pushing.

### BACKGROUND ART

Due to rapid development of advanced technology, a variety of digital devices, such as mobile phones, MP3s, PMPs, navigators, electronic dictionaries, PDAs, etc., have come to be widely used. These digital devices provide convenience in many fields.

Such digital devices are provided with number buttons or function buttons which are manipulated by users to control various functions of the devices. The users can activate the desired functions of the devices using these buttons.

FIG. 1 illustrates an example of a mobile phone. The mobile phone includes buttons, such as number buttons, a call button, direction buttons (four-way direction buttons), etc. As shown in FIG. 3, the button is configured such that a dome switch sheet is provided on a PCB (Printed Circuit Board) so that when a metal dome 1 comes into contact with a pattern 2 formed on the PCB, a corresponding key value is output and an operation signal corresponding to the key value is generated.

Recently, development and the commercialization of touch sensors have changed the manipulation method from button manipulation to touch manipulation, and many electronic devices have appeared that use touch sensors to improve the convenience of manipulation.

FIG. 2 illustrates an example of a mobile phone using a touch sensor. This mobile phone includes a display which has a front surface to which a touch sensor using an ITO film has been applied. The operation of the mobile phone can be controlled by touching the front surface of the display.

As mentioned above, the touch sensor includes the ITO film or PCB on which a predetermined pattern is formed. When it is touched by a user's body, the sensor measures the capacitance which allows a corresponding function of the device to be operated.

However, to apply touch sensors to digital devices, diamond patterns or rod-shaped patterns which are specially produced to measure the capacitance and a set of separate elements which are used to facilitate measuring of the capacitance are required.

Therefore, there are problems in that separate PCB patterns must be manufactured and the general structures of products must be changed so that the PCB patterns can be applied to the products, and the ITO films are very expensive, so that if an ITO film is used, the production cost markedly increases.

### DISCLOSURE

### Technical Problem

Accordingly, the present invention has been made keeping in mind the above problems occurring in the prior art, and an object of the present invention is to provide a button device having a touch sensing function which can be applied to the existing buttons of a variety of digital devices to enhance convenience of manipulation of the buttons without changing the structures of the buttons.

### Technical Solution

In order to accomplish the above object, the present invention provides a hybrid button device for use in a variety of host systems, including a button unit for controlling various functions of a host system using a control unit and in response to a manipulation made by a user, the button unit comprising a PCB pattern and a dome sheet and being manipulated by the user so that when the button unit is pushed by the user, a corresponding key value is output to control a function of the host system, and a capacitance measuring unit connected to the button unit, the capacitance measuring unit measuring a capacitance when the user touches the button unit, wherein when the user touches the button unit, the capacitance measuring unit determines whether to operate or not, and a corresponding key value is output by the control unit to control a corresponding function of the host system.

The capacitance measuring unit may be configured such that some or an entirety of the button unit provided in the host system is touch-sensed.

The capacitance measuring unit may be configured such that the button unit is used to recognize a character input, a four-way or eight-way direction input or a circular scroll wheel manipulation depending on a touch manipulation.

Furthermore, when the capacitance is measured by the capacitance measuring unit, the control unit may output a key value corresponding to the key value which is output by pushing the corresponding button unit, or the control unit may output a preset distinct key value.

The hybrid button device may further include a key value conversion unit connected to the control unit so that when the capacitance is measured by the capacitance measuring unit, the control unit outputs a key value distinct from the key value which is output by pushing the button unit.

### Advantageous Effects

The present invention provides a button device having a touch sensing function which can be applied to an existing dome switch type button of digital devices only by adding a capacitance measuring unit for measuring a capacitance generated between a user's body and the button without having to change the existing structure and function of the button.

Furthermore, the button device of the present invention can conduct functions which have not been able to be embodied by the existing button, thus providing enhanced convenience.

### DESCRIPTION OF DRAWINGS

FIG. 1 is a front view showing a mobile phone with a button part as an example of a typical digital device;

FIG. 2 is a front view showing a mobile phone with a touch sensor as another example of a typical digital device;

FIG. 3 is a sectional view showing a dome switch used in a variety of digital devices;

FIG. 4 is a schematic block diagram showing the construction of a hybrid button device having a touch sensing function, according to the present invention;

FIG. 5 is an exemplary view showing a method of embodying the hybrid button device having the touch sensing function according to the present invention; and

FIG. 6 is of several exemplary views showing methods of embodying the hybrid button device having the touch sensing function according to the present invention.

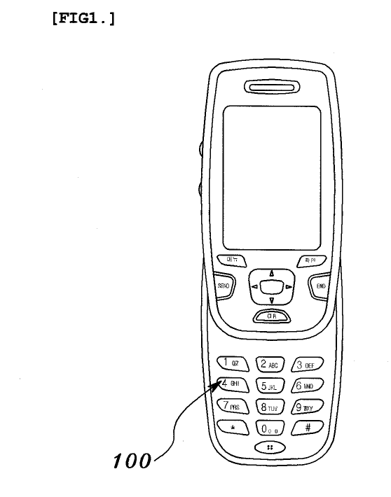

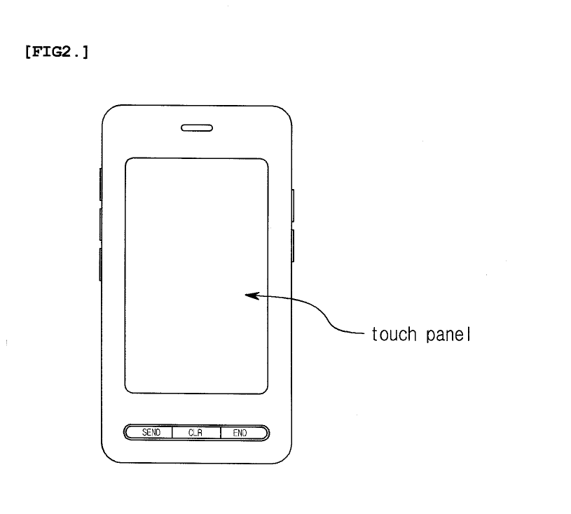

### DESCRIPTION OF THE ELEMENTS IN THE DRAWINGS

| | |
|---|---|
| 100: button unit | 110: dome switch sheet |
| 120: PCB pattern | 200: capacitance measuring unit |
| 210: key value conversion unit | 300: control unit |
| 400: host system | |

### BEST MODE

Hereinafter, a hybrid button device having a touch sensing function according to a preferred embodiment of the present invention will be described in detail with reference to the attached drawings.

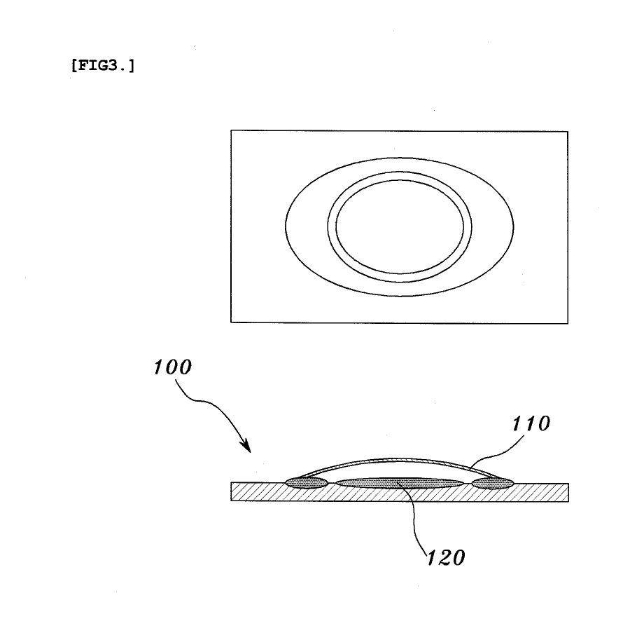

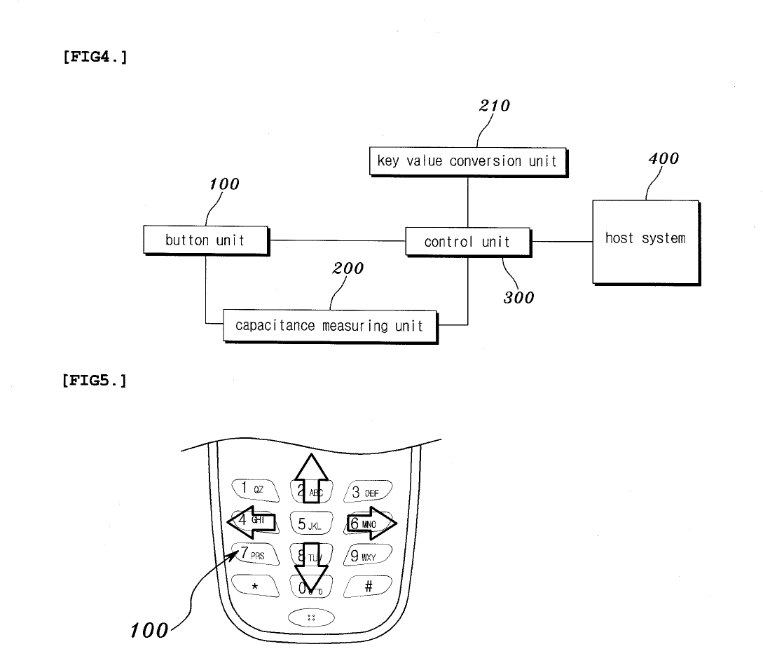

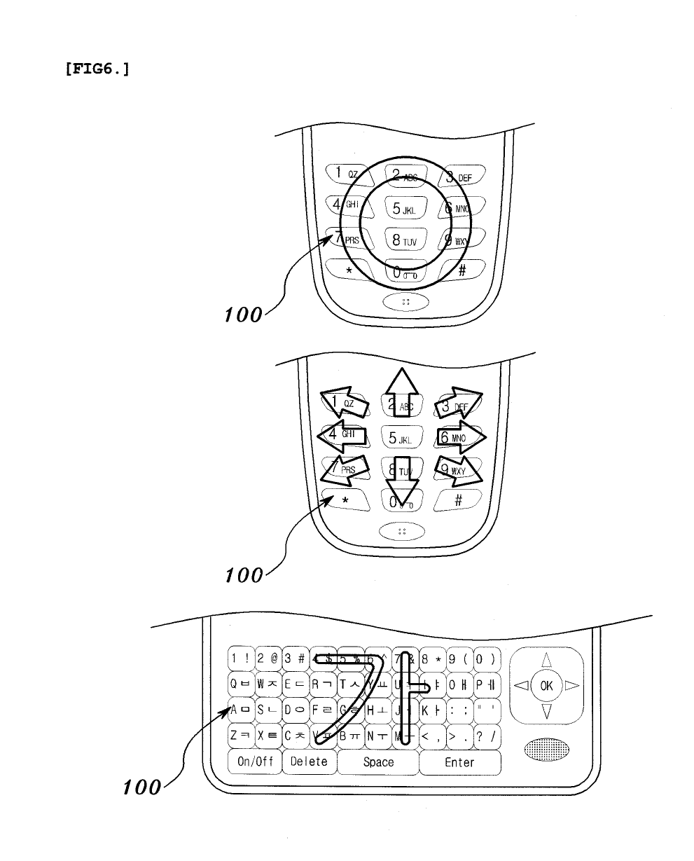

FIG. 3 is a sectional view showing a dome switch for use in a variety of digital devices. FIG. 4 is a schematic block diagram showing the construction of a hybrid button device having a touch sensing function, according to the present invention. FIG. 5 is an exemplary view showing a method of embodying the hybrid button device having the touch sensing function according to the present invention. FIG. 6 is of several exemplary views showing methods of embodying the hybrid button device having the touch sensing function according to the present invention.

The hybrid button device having the touch sensing function according to the present invention can be provided in a variety of host systems 400 and includes a button unit 100 and a capacitance measuring unit 200. The button unit 100 includes a PCB pattern 120 and a dome switch sheet 110 and is manipulated by a user so that when the button unit 100 is pushed by the user, a corresponding key value is output. The capacitance measuring unit 200 is connected to the button unit 100 to measure capacitance when the user touches the button unit 100. When the user touches the button unit 100, the capacitance measuring unit 200 determines whether to operate or not, and a corresponding key value is output by a control unit 300 to control the corresponding function of the host system 400.

The button unit 100 is installed in the host system 400 which can be a variety of digital devices, such as mobile phones, MP3s, PMPs, navigators, electronic dictionaries, PDAs, etc. The user manipulates the button unit 100 to control a variety of functions of the host system 400.

The button unit 100 includes the metal dome switch sheet 110 and the PCB pattern 120 which are configured such that contact points are formed therebetween by the pushing force of the user. This can be interpreted with reference to FIG. 3. Furthermore, a keypad on which words or patterns corresponding to the respective buttons are formed to enable the user to be aware of the functions of the buttons is disposed above the dome switch sheet. The keypad transmits the pushing force of the user to the dome switch sheet 110 so that the dome switch sheet comes into contact with the PCB pattern. Thereby, the buttons can be manipulated.

To sense the pressure with which the user pushes or releases the button unit, GPIO (general purpose input output) pins are set in the PCB pattern 120, to an open drain output mode and 0v is driven successively based on a key scan method. In the dome switch sheet 110, GPIO pins are set to an input with pull-up mode.

When the user pushes the dome switch sheet 110, the dome switch sheet comes into contact with the PCB pattern. At this time, voltage input to the dome switch sheet switches from a high logic level into a low logic level. Thereby, it is determined that the button of the corresponding pin has been pushed. When the dome switch sheet 110 is removed from the PCB pattern, the voltage input to the dome switch sheet 110 switches from a low logic level into a high logic level, so that it is determined that the button has been released.

The dome switch button unit including the dome switch sheet 110 and the PCB pattern 120 is used in a variety of digital devices, such as mobile phones or the like.

When the user manipulates each button unit 100, a corresponding key value is output. Various functions of the host system can be controlled depending on the output key vales.

The capacitance measuring unit 200 is connected to the button unit 100 without having to change the structure of the button unit 100, so that when the user touches the button unit, the capacitance measuring unit 200 measures a capacitance to embody touch manipulation. The capacitance measuring unit 200 determines whether the button has been manipulated or not by measuring a variation in the capacitance as occurs when it has been touched by the user's body.

Such a capacitance measuring unit is widely used in well-known touch sensors. The capacitance measuring unit of the present invention can also be designed and embodied by a well-known technique or a technique disclosed in Korean Patent Application No. 2007-0095453 which was filed by the applicant of the present invention, therefore a further explanation thereof will be omitted.

To sense a touch of the user, in the PCB pattern 120, the GIPO pins are set such that they all output “0” in the open drain output mode so that they are connected to 0V (ground voltage), or they all are set to an input mode to be open (a high impedance state). Subsequently, the dome switch sheet 110 is set to a mode for sensing a capacitance during the operation mode of the GIPO pins, and thereafter a sensing circuit of a capacitance sensor for sensing a touch is operated to measure the variation in the capacitance. Thereby, a touch of the user can be sensed.

Various methods can be used to embody the application of the capacitance measuring unit 200 to the button unit 100. First, the capacitance measuring unit 200 may be configured such that it outputs a key value corresponding to the function of the button unit 100 when it is pushed. In this case, the button unit can conduct the same function when subject to push manipulation as when subject to touch manipulation.

For instance, the capacitance measuring unit 200 may be configured such that the button units 100 that have upward, downward, left and right shift functions when subject to push manipulation also perform the same functions when subject to touch manipulation. In other words, the four-way shift function can be implemented by either of push and touch manipulation.

Alternatively, the capacitance measuring unit may be configured such that distinct preset key values are output when subject to touch manipulation rather than being consistent with the key values generated using push manipulation. This allows a larger variety of types of manipulations of the host system to be embodied by touch manipulation.

Referring to FIG. 5 illustrating an example of a mobile phone, the button unit includes button units on which numerals 1 to 9 and 0 and the symbols “*” and “#” are printed. When push manipulation is conducted, the button unit outputs key values pertaining to corresponding numerals or marks. When touch manipulation is conducted, four-way key values can be output. Therefore, manipulation of button units can be performed more conveniently. In this case, for four-way touch manipulation, the capacitance measurement unit is connected to button units of numerals 2, 4, 6 and 8 to measure capacitances of the button units.

Furthermore, as shown in FIG. 6, an eight-way shift function or a circular scroll wheel function may be embodied. As necessary, a separate key value conversion unit 210 may be provided. In this case, when a capacitance is measured, a preset key value is output in response to touch manipulation by the key value conversion unit 210.

As another embodiment, character recognition can be embodied by touch manipulation. As shown in FIG. 6, in the case where the button unit comprises a plurality of button units, each button is provided with a capacitance measuring unit. When capacitances of the button units which are generated by touch manipulation are measured, a character is recognized by the key value conversion unit 210, so that various characters can be input. Although it is not shown in the drawings, the present invention may further include a character recognition unit for recognizing output key values as a character so that when the user expresses a character using the button units, the character recognition unit can recognize the character as such.

Meanwhile, to distinguish push and touch manipulation of the button unit from each other, key values are determined in such a way that a key value generated by a push manipulation is first calculated before a capacitance resulting from a touch manipulation is measured. As such, the result of input can be output by successively measuring the push manipulation and the touch manipulation for a predetermined time difference.

In detail, values measured by the two button manipulation methods are independently transmitted to the host system. Then, in an application program using push manipulation, only data measured by the push manipulation method is used, whereas in an application program using touch manipulation, only data measured by the touch manipulation method is used.

Alternatively, a separate touch manipulation drive button may be provided in a digital device. In this case, the touch manipulation function can be on/off controlled. That is, when the touch manipulation function is necessary, the touch manipulation drive button is turned on and key values are output by the touch manipulation, and when the touch manipulation function must be interrupted, the touch manipulation drive button is turned off.

As a further alternative, the present invention may be configured such that when there has been no touch input for a predetermined amount of time, the touch manipulation function is automatically interrupted, or when an application program which does not require the touch manipulation function is operated, the touch manipulation function is interrupted.

The button device having the touch manipulation function according to the present invention can be configured such that it corresponds to an existing button matrix having a plurality of button units or that a separate key value is output to control a host system. Therefore, the button device of the present invention can be applied to a variety of host systems.

In the present invention, the capacitance measuring unit 200 measures a capacitance of the button unit, and the control unit 300 outputs a key value corresponding to the measured capacitance so that the host system is controlled in response to the key value.

As described above, a button device having a touch sensing function according to the present invention can be provided by adding only a capacitance measuring unit to an existing button unit provided in a variety of digital devices without changing the structure of the button unit. Therefore, the production cost can be reduced, and manipulating buttons can be made more convenient.

Although the preferred embodiments of the present invention have been disclosed for illustrative purposes, the present invention is not limited to the construction and operation of the embodiments.

Those skilled in the art will appreciate that various modifications, additions and substitutions are possible, without departing from the scope and spirit of the invention as disclosed in the accompanying claims. Therefore, all these modifications, additions and substitutions should be regarded as falling within the bounds of the present invention.

1. A hybrid button device for use in a variety of host systems, comprising:
a button unit for controlling various functions of a host system using a control unit and in response to a manipulation made by a user, the button unit comprising a PCB pattern and a dome sheet and being manipulated by the user so that when the button unit is pushed by the user, a corresponding key value is output to control a function of the host system; and
a capacitance measuring unit connected to the button unit, the capacitance measuring unit measuring a capacitance when the user touches the button unit,
wherein when the user touches the button unit, the capacitance measuring unit determines whether to operate or not, and a corresponding key value is output by the control unit to control a corresponding function of the host system.

2. The hybrid button device as set forth in claim 1, wherein the capacitance measuring unit is configured such that some or an entirety of the button unit provided in the host system is touch-sensed.

3. The hybrid button device as set forth in claim 1, wherein the capacitance measuring unit is configured such that the button unit is used to recognize a character input, a four-way or eight-way direction input or a circular scroll wheel manipulation depending on a touch manipulation.

4. The hybrid button device as set forth in claim 1, wherein when the capacitance is measured by the capacitance measuring unit, the control unit outputs a key value corresponding to the key value which is output by pushing the corresponding button unit, or the control unit outputs a preset distinct key value.

5. The hybrid button device as set forth in claim 1, further comprising:
a key value conversion unit connected to the control unit so that when the capacitance is measured by the capacitance measuring unit, the control unit outputs a key value distinct from the key value which is output by pushing the button unit.

6. The hybrid button device as set forth in claim 2, wherein the capacitance measuring unit is configured such that the button unit is used to recognize a character input, a four-way or eight-way direction input or a circular scroll wheel manipulation depending on a touch manipulation.

7. The hybrid button device as set forth in claim 4, further comprising:
a key value conversion unit connected to the control unit so that when the capacitance is measured by the capacitance measuring unit, the control unit outputs a key value distinct from the key value which is output by pushing the button unit.
